(19) United States
(12) Patent Application Publication
(10) Pub. No.: US 2023/0243375 A1
(43) Pub. Date: Aug. 3, 2023

(54) RELEASABLE IMPACT MITIGATING FASTENER

(71) Applicant: VICIS IP, LLC, New York, NY (US)

(72) Inventors: Andre Stone, Seattle, WA (US); Jason Neubauer, Seattle, WA (US); Adam Kollgaard, Seattle, WA (US); Travis Glover, Seattle, WA (US); Marie Pahlmeyer, Seattle, WA (US); Per Reinhall, Seattle, WA (US)

(21) Appl. No.: 17/929,246

(22) Filed: Sep. 1, 2022

Related U.S. Application Data
(62) Division of application No. 16/396,442, filed on Apr. 26, 2019, now abandoned.
(60) Provisional application No. 62/664,801, filed on Apr. 30, 2018.

(51) Int. Cl. F16B 5/06

(52) U.S. Cl. CPC F16B 5/0657; A42B 3/12

(57) ABSTRACT

The releasable impact mitigating fasteners is an adaptable mechanism that may be used as the main energy management source and/or be used as a supplemental energy management source. The improved releasable impact mitigating fasteners are easily incorporated into protective devices such as helmets and/or other protective gear for a variety of activities, applications and/or industries, that require enhanced impact absorption, reusability, and/or quick release capabilities under specifically designed impact loads, etc. Each of the releasable impact mitigating fasteners comprise a first end, a second end and an impact mitigation structure. The first end comprises a face plate, the second end may comprise at least one flange. Each of the releasable impact mitigating fasteners may further comprise a base.

### CROSS-REFERENCE TO RELATED APPLICATIONS

This application is a divisional application of, and claims priority to, U.S. patent application Ser. No. 16/396,442, entitled “Releasable Impact Mitigating Fastener,” filed Apr. 26, 2019, which claims the benefit of U.S. Provisional Application No. 62/664,801, entitled “Releasable Fastener,” filed Apr. 30, 2018. The disclosure of the foregoing applications are incorporated by reference herein in their entirety.

### TECHNICAL FIELD

The present invention relates to methods, devices, and systems for improving a helmet or other item of protective clothing with releasable impact mitigating fasteners and/or releasable impact mitigation structures that allow for modular component replacement and/or enhanced impact absorption performance. More specifically, the present invention relates to releasable impact mitigating fasteners and/or releasable impact mitigation structures for connecting components of protective devices such as helmets and/or other protective gear for a variety of activities, including athletic competitions, law enforcement and/or military operations.

### BACKGROUND

There are a variety of traditional helmets that provide for releasable helmet retention mechanisms that secures the outer shell to the impact mitigation layer and/or padding. However, the current releasable helmet retention systems only provide limited functions that focus on securing and release. The retention systems do not have impact mitigation properties and its release function is usually designed to break or fail allowing the outer shell to displace or move relative to the other layers for enhanced energy management purposes—e.g., absorb and divert forces that would typically be transferred to a wearers' head and neck. Such a design typically results in single use helmet requiring the helmet to be destroyed, repaired and/or replaced leading to increased costs to the wearer.

### SUMMARY OF THE INVENTION

As a result, a need exists for an improved helmet system and/or an improved article of clothing that incorporates a releasable impact mitigating fastener that contains a variety of functions, including securing, releasing, impact mitigating, re-attachment, and/or any combination thereof. Such an improved helmet system would be advantageous to the wearer because it would enhance energy management of the helmet, reduce future repair and/or replacement costs to the wearer, reduce manufacturing costs by removing duplicative parts, and/or potentially make the helmet system lighter, etc.

In one embodiment, the releasable impact mitigating fastener can be incorporated into a helmet system to provide a supplementary impact mitigation function to the impact mitigation layer. The helmet system may comprise an outer shell, an inner shell, an impact mitigation layer. The impact mitigation layer may be disposed between the outer and inner shell. The impact mitigation layer may comprise impact mitigation structures and at least one releasable impact mitigating fastener. The impact mitigation layer may further comprise a force distribution layer and/or a foam layer. The at least one releasable impact mitigating fastener may be positioned adjacent to an impact structure and also releasably couple the inner to the outer shell. The at least one releasable impact mitigating fastener may further comprise first end proximate to an inner surface of the outer shell, and a second end proximate to the outer surface of the inner shell. In other embodiments, the at least one releasable impact mitigating fastener may comprise a first end and/or second end, the first end may comprise a face plate, the first end may be coupled to the inner and/or outer shell. The second end may be coupled to the inner and/or outer shell. The at least one releasable impact mitigating fastener may comprise an impact mitigation structure.

In another embodiment, the releasable impact mitigating fastener can be incorporated into a helmet system to provide the main impact mitigation function within the impact mitigation layer. The helmet system may comprise an outer shell, an inner shell, an impact mitigation layer. The impact mitigation layer may be disposed between the outer and inner shell. The impact mitigation layer may comprise a plurality of impact releasable impact mitigating fasteners. The impact mitigation layer may further comprise a force distribution layer and/or a foam layer. Each of the plurality of impact releasable impact mitigating fasteners may comprise an impact mitigation structure and will also releasably couple the inner to the outer shell and/or couple to the inner or the outer shell. The at least one releasable impact mitigating fastener may further comprise first end proximate to an inner surface of the outer shell, and a second end proximate to the outer surface of the inner shell. In other embodiments, the at least one releasable impact mitigating fastener may comprise a first end and/or second end, the first end may comprise a face plate, the first end may be coupled to the inner and/or outer shell. The second end may be coupled to the inner and/or outer shell, the second end may comprise one or more flanges.

In various embodiments, a releasable impact mitigating fastener can be provided with differential decoupling characteristics for compressive, tensional and/or lateral loading, with each decoupling characteristic particularized based on the design, arrangement and/or size of the releasable impact mitigating fastener components, as well as the various material characteristics thereof. Such designs may have particular utility in a wide variety of helmet applications, including in the anchoring of facemasks to a football helmet, where significant compressive loading may be desired (i.e., to protect the player's face from direct impacts on the face mask), while allowing for much lower decoupling forces between the facemask and helmet where the facemask may be tensioned and/or tangentially loaded (i.e., where the player receives a glancing facemask blow and/or is being grabbed by the facemask by an opposing player), which could allow the facemask to decouple from the helmet in a desired manner. In a similar manner, various embodiments could provide decoupling characteristics based on the direction and/or angle of impact to the helmet (and thus to the connector), wherein the connector can present a different decoupling force depending upon the incident angle and/or magnitude of the impacting force (i.e., a different decoupling force for impact from the bottom up on the helmet versus the top down).

Moreover, releasable impact mitigating fasteners as described herein could be utilized to connect to various components of a protective helmet, such as a facemask, chinstrap, jaw pads to helmet, skull cap to helmet, between an outer layer and an inner layer of the helmet, between the inner/outer layer to comfort liner assembly, and/or any combination thereof, including designs with at least a portion of the body of the releasable impact mitigating fastener positioned within and/or adjacent to an impact absorbing layer of the helmet. Desirably, this arrangement would provide a durable connection between individual helmet components, but would mitigate, limit and/or prevent the transmission of impact forces via the various connector components (i.e., front the outer helmet through the connector to the inner helmet), which commonly occurs with many existing connector designs.

### BRIEF DESCRIPTION OF THE DRAWINGS

FIG. 1 depicts an isometric cross-sectional view of one embodiment of a releasable impact mitigating releasable impact mitigating fastener;

FIGS. 2A-2B depict a top and bottom view of an alternate embodiment of a releasable impact mitigating releasable impact mitigating fastener;

FIGS. 3A-3B depict a cross-sectional and top view of an alternate embodiment of a releasable impact mitigating releasable impact mitigating fastener;

FIGS. 4A-4B depict a top and bottom view of an alternate embodiment of a releasable impact mitigating releasable impact mitigating fastener;

FIGS. 5A-5C depict a cross-sectional and isometric view of an alternate embodiment of a releasable impact mitigating releasable impact mitigating fastener;

FIGS. 6A-6C depict a cross-sectional and isometric view of an alternate embodiment of a releasable impact mitigating releasable impact mitigating fastener;

FIGS. 7A-7C depict a cross-sectional and side view of an alternate embodiment of a releasable impact mitigating releasable impact mitigating fastener;

FIGS. 8A-8B depicts cross-sectional views of an alternate embodiment of a releasable impact mitigating releasable impact mitigating fastener;

FIGS. 9A-9B depict cross-sectional views of an alternate embodiment of a releasable impact mitigating releasable impact mitigating fastener;

FIGS. 10A-10B depict cross-sectional views of an alternate embodiment of a releasable impact mitigating releasable impact mitigating fastener;

FIGS. 11A-11B depict cross-sectional views of an alternate embodiment of a releasable impact mitigating releasable impact mitigating fastener;

FIGS. 12A-12B depict cross-sectional views of an alternate embodiment of a releasable impact mitigating releasable impact mitigating fastener;

FIG. 13 depicts cross-sectional views of an alternate embodiment of a releasable impact mitigating releasable impact mitigating fastener;

FIG. 14 depicts a side view of an alternate embodiment of a releasable impact mitigating releasable impact mitigating fastener;

FIGS. 15A-15B depict cross-sectional views of an alternate embodiment of a releasable impact mitigating releasable impact mitigating fastener;

FIG. 16 depicts a cross-sectional view of an alternate embodiment of a releasable impact mitigating releasable impact mitigating fastener; and

FIGS. 17A-17B depict a cross-sectional view of a helmet system with a releasable impact mitigating fastener.

### DETAILED DESCRIPTION

The helmet system relates to a helmet with one or more releasable impact mitigating fasteners capable of providing a substantial level of impact resistance, including vertically and/or semi-vertically oriented loads (i.e., wholly or partially outward and/or inward impacts on a helmet) while providing for partial and/or complete release and/or decoupling of the releasable impact mitigating fastener components when the helmet experiences much lower torsional and/or tangential loading. As a result, a releasable impact mitigating fastener with enhanced impact mitigation properties can be designed to accommodate a variety of impact scenarios when one or more specific loading scenarios are encountered.

Although, the focus of the disclosure relates to helmet systems, a releasable impact mitigating fastener may be used in other industries and/or as retention mechanisms for other components within a helmet and/or protective clothing. In various embodiments, releasable impact mitigating fasteners of various designs could be mounted almost anywhere in and/or on the helmet or other protective clothing, including virtually anywhere between the inner and/or outer shells of the helmet, as well as any first material layer and/or second material layers of protective clothing. Such protective clothing may include helmets, goggles, garments, shields, masks, safety booths, body armor, and/or other blunt-force trauma protective clothing or gear. Accordingly, such releasable impact mitigating fastener may be specifically used within sporting helmets. For example, the releasable impact mitigating fasteners could be positioned adjacent to one another, or spread out to various helmet locations, including at both the front and/or back of the helmet, and/or at multiple spaced apart locations. If desired, a releasable impact mitigating fastener could comprise two or more releasable impact mitigating fasteners bodies stacked together (i.e., on top of one another, for example).

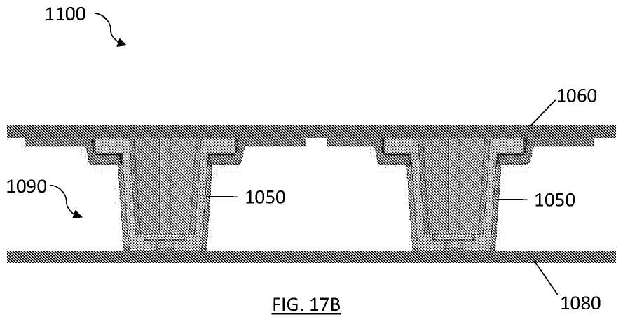

In one exemplary embodiment, the releasable impact mitigating fastener can be incorporated into a helmet system 1030 to provide a supplementary impact mitigation function to the impact mitigation layer as shown in FIG. 17A. The helmet system may comprise an outer shell 1060, an inner shell 1080, an impact mitigation layer 1090. The impact mitigation layer 1090 may be disposed between the outer 1060 and inner shell 1080. The impact mitigation layer 1090 may comprise impact mitigation structures 1040 and at least one releasable impact mitigating fastener 1050. The impact mitigation layer 1090 may further comprise a force distribution layer (not shown) and/or a foam layer (not shown).

The at least one releasable impact mitigating fastener 1050 may be positioned adjacent to an impact structure 1040 and also releasably couple the inner shell 1080 to the outer shell 1060. The impact mitigation structures 1040 may comprise a plurality of filaments, a plurality of laterally supported filament structures, auxetic structures, a plurality of undulated structures, and/or any combination thereof. Each of the at least one releasable impact mitigating fasteners 1050 are spaced apart and independently acting as impact absorbing members that are elastically collapsible and/or elastically buckle in response to an impact. The at least one releasable impact mitigating fastener 1050 will supplement and/or provide additional support for energy management, thus, collectively significantly reduce the impact forces transmitted to the wearer. The at least one releasable impact mitigating fastener 1050 may further comprise first end proximate to an inner surface of the outer shell 1060, and a second end proximate to the outer surface of the inner shell 1080. In other embodiments, the at least one releasable impact mitigating fastener 1050 may comprise a first end and/or second end, the first end may comprise a face plate, the first end may be coupled to the inner shell 1080 and/or the outer shell 1060. The second end may be coupled to the inner shell 1080 and/or outer shell 1060, the second may further comprise at least one flange or one or more flanges.

In another embodiment, the releasable impact mitigating fastener can be incorporated into a helmet system 1100 to be utilized as the impact mitigation layer 1090 as shown in FIG. 17B. The helmet system 1100 may comprise an outer shell 1060, an inner shell 1080, an impact mitigation layer 1090. The impact mitigation layer 1090 may be disposed between the outer 1060 and inner 1080 shell. The impact mitigation layer 1090 may comprise a plurality of impact releasable impact mitigating fasteners 1050. The impact mitigation layer 1090 may further comprise a force distribution layer (not shown) and/or a foam layer (not shown). Each of the plurality of impact releasable impact mitigating fasteners 1050 may comprise an impact mitigation structure and will also releasably couple the inner shell 1080 to the outer shell 1060. The at least one releasable impact mitigating fastener 1050 may further comprise first end proximate to an inner surface of the outer shell 1060, and a second end proximate to the outer surface of the inner shell 1080. In other embodiments, the at least one releasable impact mitigating fastener 1050 may comprise a first end and/or second end, the first end may comprise a face plate, the first end may be coupled to the inner shell 1080 and/or the outer shell 1060. The second end may be coupled to the inner shell 1080 and/or outer shell 1060, the second end may comprise one or more flanges and/or at least one flange.

The impact mitigation structures may comprise a plurality of filaments, a plurality of laterally supported filament structures, auxetic structures, undulating structures, and/or any combination thereof. Each of the impact mitigation structures may be positioned adjacent to another impact mitigation structure to form a shape, the shape may comprise a circle and/or a polygon. Alternatively, the plurality of filaments may be positioned adjacent to another filament to form a shape, the shape may comprise a circle and/or a polygon. The polygons may comprise a triangle, a square, a rectangle, a pentagonal, hexagonal, heptagon, octagon, and/or any combination thereof. Each of the at least one releasable impact mitigating fasteners 1050 are spaced apart and independently acting as impact absorbing members that are elastically collapsible and/or elastically buckle in response to an impact. The at least one impact releasable impact mitigating fastener 1050 will be the main energy management source to reduce the impact forces transmitted to the wearer.

The outer shell 1060 may be manufactured from a relatively rigid material or rigid material, such as polyethylene, nylon, polycarbonate materials, acrylonitrile Butadiene Styrene (ABS), polyester resin with fiberglass, thermosetting plastics, and/or any other rigid thermoplastic materials. Alternately, the outer shell 1060 may be manufactured from a relatively deformable material, such as polyurethane and/or high-density polyethylene, where such material allows some flexibility and/or local deformation upon impact, but provide enough rigidity to prevent the breakage or damage to the helmet.

The inner shell 1080 may be manufactured from a relatively rigid or rigid material. The inner shell 1080 being nested within the impact mitigation layer 1090. The inner shell 1080 having an exterior surface and an interior surface, the at least a portion of the exterior surface of the inner shell 1080 may contact an exterior surface of the impact mitigation layer 1090. The at least one inner shell 1090 being a continuous shell that conforms and surrounds the head of the wearer. Accordingly, the at least one inner shell 1080 may be a rigid material. The at least one inner shell 1080 may be more rigid than the outer shell 1060 and/or more rigid than the impact mitigation layer 1090. In some embodiments, the inner shell 1080 is five to 100 times stiffer or more rigid than the outer shell 1060 and/or the impact mitigation layer. The rigid material may comprise polycarbonate (PC). Alternatively, the inner shell 1080 comprises a relatively rigid material or relatively stiff material. The relatively rigid material may be stiff or rigid enough to withstand breakage or cracking, but flexible enough to deform slightly and distribute incident forces after an impact. The at least one inner shell 1080 may comprise a thermoplastic material. Thermoplastic materials may comprise polyurethane, polycarbonate, polypropylene, polyether block amide, and/or any combinations thereof. Alternatively, the inner shell 1080 may comprise a deformable material, such as polyurethane and/or high-density polyethylene, where such material allows some flexibility and/or local deformation upon impact, but provide enough rigidity to prevent the breakage or damage to the helmet.

### Impact Mitigation Structures

In one embodiment, the helmet system may comprise an outer shell, an inner shell, an impact mitigation layer. The impact mitigation layer may be disposed between the outer and inner shell. The impact mitigation layer may comprise a plurality of releasable impact mitigating fasteners, each of the plurality of the releasable impact mitigating fasteners may comprise an impact mitigating structure. The plurality of releasable impact mitigating fasteners may further comprise first end proximate to an inner surface of the outer shell, and a second end proximate to the outer surface of the inner shell. In other embodiments, the plurality of releasable impact mitigating fasteners may comprise a first end and/or second end, the first end may comprise a face plate, the first end may be coupled to the inner shell and/or the outer shell. The second end may be coupled to the inner shell and/or outer shell.

Alternatively, the helmet system may comprise an outer shell, an inner shell, an impact mitigation layer. The impact mitigation layer may be disposed between the outer and inner shell. The impact mitigation layer may comprise one or more impact mitigation structures and one or more releasable impact mitigation fasteners. If desired, the releasable impact mitigating fasteners could be positioned within the impact mitigating layer, such that the each of the plurality releasable impact mitigating fasteners are positioned adjacent to an impact mitigating structure, the impact mitigating structures can surround or substantially surround each of the releasable impact mitigating fasteners, with at least a portion of the releasable impact mitigating fasteners responding to external impacts in a manner similar to the surrounding impact mitigating structures. The plurality of releasable impact mitigating fasteners may further comprise first end proximate to an inner surface of the outer shell, and a second end proximate to the outer surface of the inner shell. In other embodiments, the plurality of releasable impact mitigating fasteners may comprise a first end and/or second end, the first end may comprise a face plate, the first end may be coupled to the inner shell and/or the outer shell. The second end may be coupled to the inner shell and/or outer shell, the second end may comprise at least one flange.

In one embodiment, the releasable impact mitigation fastener designs described herein could be used to connect a variety of helmet components together, including impact absorbing and/or impact mitigating structural components to other components of the helmet (or sandwiched between helmet layers that are connected by releasable impact mitigating fasteners) and/or be used as the main structure for energy management. The impact mitigation structures and/or the releasable impact mitigating fastener may comprise at least a portion of filaments, at least a portion of laterally supported filaments, at least a portion of auxetic structures, at least a portion of zigzag structures, at least a portion of herringbone structures, at least a portion of chevron structures, impact foam or foam layer, TPU structures and/or “cones,” inflatable bladders, shock bonnets, and/or any combination thereof.

In another embodiment, the impact mitigating structure and/or the releasable impact mitigating fastener may comprise at least a portion of filaments. In one embodiment, the impact mitigating structures can comprise at least a portion of filaments. The at least a portion of filaments may be thin, longitudinally extending members or be shaped and configured to deform non-linearly in response to an impact force. Each of the at least a portion of filaments having a high aspect ratio, the aspect ratio being a range of 3:1 to 1,000:1, where the length of each filament is greater than the width. The non-linear deformation behavior is expected to provide improved protection against high-impact forces, and/or oblique forces. The non-linear deformation behavior is described by at least a portion of the filaments stress-strain profile. The non-linear stress-strain profile illustrates that there can be an initial rapid increase in force (region I) followed by a change in slope that may be flat, decreasing or increasing slope (region II), followed by a third region with a different slope (region III).

In another embodiment, the at least a portion of the filaments may comprise filaments that buckle in response to an incident force, where buckling may be characterized by a localized, sudden failure of the filament structure subjected to high compressive stress, where the actual compressive stress at the point of failure is less than the ultimate compressive stress that the material is capable of withstanding. Furthermore, the at least a portion of the filaments may be configured to deform elastically, allowing the at least a portion of the filaments to substantially return to their initial configuration once the external force is removed. The at least a portion of filaments may extend between two surfaces, the at least a portion of filaments having at least one end coupled to the outer layer and/or the inner layer.

In another embodiment, the impact mitigating structure and/or the releasable impact mitigating fastener may comprise at least a portion of laterally supported filaments (LSFs). A laterally supported filament may comprise at least a portion of a plurality of filaments that are interconnected by laterally positioned walls or sheets, where each of the plurality of filaments are positioned proximate to an adjacent each of the plurality of filaments, where such positioning forms a shape. The shape may be a circle and/or a polygonal configuration forming a structure that is otherwise known as laterally supported filaments (LSF). In various embodiments, at least a portion of the impact mitigation structure and/or releasable impact mitigating releasable impact mitigating fastener can be arranged in a hexagonal pattern with filaments interconnected by laterally positioned walls. Alternatively, other polygonal structures known in the art may be contemplated, such as triangular, square, pentagonal, hexagonal, septagonal, octagonal, and/or any combination thereof. A plurality of sheets or lateral walls can be secured between adjacent pairs of filaments with each filament having a pair of lateral walls attached thereto. The shape, wall thickness or diameter, height, and configuration of the lateral walls and/or filaments may vary to “tune” or “tailor” the structure to a desired performance. For example, one embodiment of a hexagonal structure may have a tapered or frusto-conical configuration. The hexagonal structure can have a top surface and/or a bottom surface, with the bottom surface perimeter (and/or bottom surface thickness/diameter of the individual elements) that may be larger than the corresponding top surface perimeter (and/or individual element thickness/diameter). In another example, the hexagonal structure can have an upper plate or ridge, which could facilitate connection to another structure, such as an inner surface of a helmet, an item of protective clothing, and/or a mechanical connection (e.g., a grommet or plug having an enlarged tip that is desirably slightly larger than the opening in the upper ridge of the hexagonal element).

In another embodiment, the impact mitigation structure and/or the releasable impact mitigating fasteners may be manufactured as an individual structure or in a patterned array. The individual structures can be manufactured using an extrusion, investment casting or injection molding process. Each individual polygonal or hexagonal structure may be affixed directly to a base in a custom location or pattern that may be arranged in continuous or segmented array. Also, they may have the same shape and configuration with repeating symmetrical arrangement or asymmetrical arrangement and/or different shape and configurations with repeating symmetrical arrangement or asymmetrical arrangement.

In one exemplary embodiment, a polygonal or hexagonal structure may be manufactured directly into a patterned array of impact absorbing structures that are affixed to at least one base membrane. The base membrane may be manufactured with a polymeric or foam material. The polymeric or foam material may be flexible and/or elastic to allows it to be easily bent, twisted or flexed to conform to complex surfaces. Alternatively, the polymeric and/or foam material may be substantially rigid. The manufacturing of each patterned array of polygonal or hexagonal structures may include extrusion, investment casting or injection molding process. The base membrane with the polygonal or hexagonal structures may be affixed directly to at least a portion of the base or the entirety. Affixing each pattered array of polygonal or hexagonal structures may be arranged in continuous or segmented arrays. Also, the polygonal or hexagonal structures may have the same shape and configuration with repeating symmetrical arrangement or asymmetrical arrangement and/or different shape and configurations with repeating symmetrical arrangement or asymmetrical arrangement.

In another embodiment, the impact mitigation structure and/or the releasable impact mitigating fastener may comprise at least a portion of an auxetic structure. The auxetic structure may include a plurality of interconnected members forming an array of reentrant shapes positioned on the flexible head layer. The term “auxetic” generally refers to a material or structure that has a negative Poisson ratio, when stretched, auxetic materials or structures become thicker (as opposed to thinner) in a direction perpendicular to the applied force. Such auxetic structures can result in high energy absorption and/or fracture resistance, and may be particularly useful in releasable impact mitigating fasteners such as contemplated herein. In particular, when a force is applied to the auxetic material or structure, the impact can cause it to expand (or contract) in one direction, resulting in associated expansion (or contraction) in a perpendicular direction. It should be recognized that those skilled in the art could utilize auxetic structures to include differently shaped segments or other structural members and different shaped voids.

In another embodiment, the impact mitigation structure and/or the releasable impact mitigating fastener may comprise a portion of a foam or foam layer, with a series of openings formed through the structure to accommodate one or more releasable impact mitigating fasteners as described herein. The foam or foam layer may comprise ethylene-vinyl acetate (EVA) foam, polyurethane (PU) foam, polyethylene (PE) foam, Supreem foam, Poron XRD foam, closed cell foam, open cell foam, polymeric foams, quantum foams, XPS foam, polystyrene foam, phenolic, memory foam (traditional, open cell, or gel), latex rubber foam, convoluted foam (“egg create foam”), Evlon foam, impact hardening foam and/or any combination thereof. In addition, the foam or foam layer may be thermoformed, molded, machined, and/or any formed using any methods known in the art.

In another embodiment, the impact mitigation structure and/or the releasable impact mitigating fastener may comprise undulating structures. The undulating structures may comprise a zig zag, herringbone and/or chevron structures. Each of these undulating structures may have structural features characterized by a repeating sinusoidal geometry or sinusoidal folds that facilitate impact absorption by being elastically collapsible and/or elastically buckling. Such undulating structures may be used in a single layer, or multi-layer. The multilayer may be stacked, where each single undulating structure layer is placed on top of the first or base undulating structure.

### Releasable Impact Mitigating Fastener

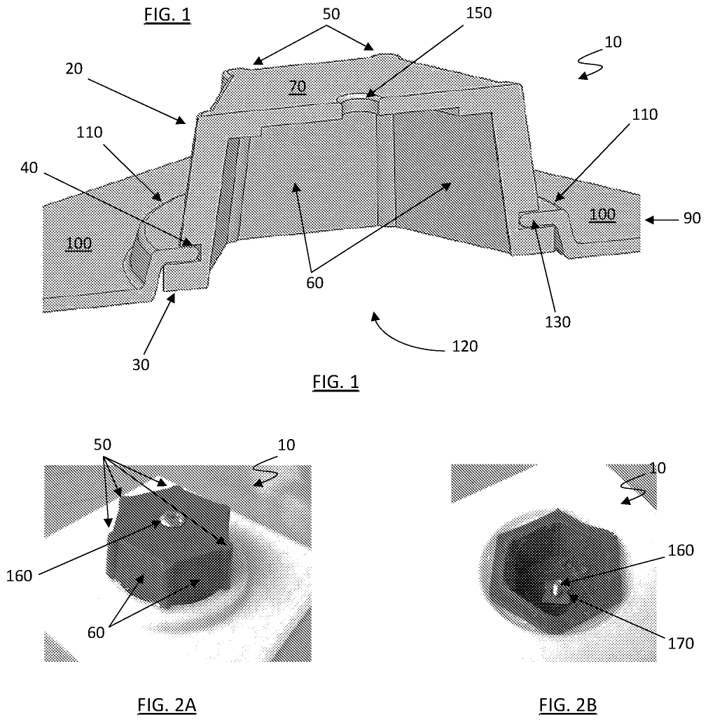

FIG. 1 depicts one exemplary embodiment of a releasable impact mitigating fastener 10. The releasable impact mitigating fastener 10 having an upper body 20, a lower ridge 30 and a circumferential groove 40, the circumferential groove 40 disposed on an external surface of the upper body 20. The releasable impact mitigating fastener 10 may further comprise a connector base 90. The connector base 90 comprising a lower portion 100 and a raised ridge 110, the ridge 110 having an opening 120 with a circular rim 130 formed therein. The plurality of releasable impact mitigating fasteners 10 may further comprise first end proximate to an inner surface of the outer shell, and a second end proximate to the outer surface of the inner shell. In other embodiments, the plurality of releasable impact mitigating fasteners 10 may comprise a first end and a second end, the first end may comprise a face plate, the first end may be coupled to the inner shell and/or the outer shell. The second end may be coupled to the inner shell and/or outer shell, the second end may comprise at least one flange and/or one or more flanges.

The connector base 90 may comprise an independent component that may be coupled to the outer shell (not shown) and/or to the inner shell (not shown) and/or the connector base 90 may comprise at least a portion of the inner shell or outer shell. More specifically, the connector base 90 may be coupled and/or affixed to an internal surface of the outer shell and/or an external surface of the inner shell. Such configuration allows the releasable impact mitigating fastener 10 to extend between the outer shell to the inner shell, but only affixed by the connector base 90 to either the inner shell and/or outer shell, and leaving the opposite end free or floating being adjacent or in contact with the inner and/or outer shell. Alternatively, the connector base 90 may be coupled to the inner and/or outer shell, and the face plate 70 may be coupled to the inner and/outer shell. In one exemplary embodiment, the helmet system may comprise a hybrid releasable impact mitigating fastener construction. Such construction comprises a first releasable impact mitigating fastener 10 to be attached to an inner surface of an outer helmet shell, with a corresponding second releasable impact mitigating fastener 10 attached to an outer surface of an inner helmet shell, with the first and second releasable impact mitigating fasteners possibly freely floating relative to each other and/or connected together at their respective connector bases 90. In addition, the connector base 90 may be integrated with the inner and/or outer shell, where the connector base 90 may extend upwardly from the inner and/or outer shell forming a protruding structure with a cavity. Accordingly, the connector base 90 may comprise a portion of the inner shell and/or a portion of the outer shell.

Upon assembly, the upper body 20 of the releasable impact mitigating fastener 10 will desirably extend through and be “captured” within the opening 120 of the base 90 as shown in FIGS. 2A-2B. At least a portion of the circular rim 130 may be positioned within the groove 40 of the releasable impact mitigating fastener 10. If desired, an upper opening 150 can be formed in the face plate 70, which in this embodiment contains a screw or bolt 160 and nut 170, which can be attached to some other helmet component or feature in a conventional manner. The circumferential groove 40 is sized and configured to receive the circular rim 130, and the circular rim 130 is sized and configured to be disposed within the circumferential groove 40. If desired, the opening 150 may be threaded. The releasable impact mitigating fastener may partially or wholly comprise an elastic or deformable material, if desired. In various embodiments, a wide variety of materials could be employed in the construction of the disclosed releasable impact mitigating fasteners and/or portions thereof, including TPU, TPE and/or silicone. Alternatively, the releasable impact mitigating fastener 10 could be cast in various elastomers, and then various stackup/elastomer/Pebax components could be created for flat pad testing.

In use, the releasable impact mitigation fastener 10 will desirably provide a significantly strong yet flexible connection between the plate 70 and the screw 160 (and between the various helmet components attached thereto), which can be particularized in how the releasable impact mitigation fastener 10 responds to various forces. For example, a downwardly directed impact force could desirably compress the face plate 70 towards the base 90, and the “response” of the releasable impact mitigation fastener 10 to this compression can be modified in a variety of ways by changing the size, shape and/or configuration of each of the plurality filaments 50 and/or a portion of the filaments 50, which can include control over the force at which the rim 130 and groove 40 of the releasable impact mitigating fastener 10 will “push” together and/or decouple (which in this embodiment might allow the body to slide back through the opening 120). In contrast, an upwardly directed tensile force on the connector could “pull” the rim 130 and groove 40 apart, drawing the base 90 out of the opening 120. As a third option, a tangential and/or rotational force of sufficient magnitude on the connector could cause the base 90 to “buckle,” which could cause decoupling of the rim 130 and groove 40 at a much lower force level, resulting in disconnection of the releasable impact mitigating fastener 10.

The releasable impact mitigating fastener 10 may comprise an impact mitigation structure. The impact mitigation structure may comprise laterally supported filaments formed into a shape. The laterally supported filaments may comprise a plurality of filaments 50 that are interconnected by laterally positioned walls or sheets 60 in a polygonal pattern. The polygonal pattern may comprise a triangular, square, pentagonal, hexagonal, septagonal, octagonal, and/or any combination thereof configuration. In one embodiment, the releasable impact mitigating fastener can be in hexagonal configuration, or a hexagonal structure. The hexagonal structure(s) or polygonal structures may be manufactured as individual structures or in a patterned array. The manufacturing may include extrusion, investment casting or injection molding process.

In this embodiment, the at least a portion of the plurality of filaments 50 are connected at an upper end by a face plate 70 or other structure, which is oriented somewhat perpendicular to the longitudinal axis of the at least a portion of the plurality of filaments 50 and/or sheets 60. A plurality of sheets or lateral walls 60 can be secured between adjacent pairs of filaments 50, with each of the plurality of filaments 50 having a pair of lateral walls 60 attached thereto. In the disclosed embodiment, the lateral walls 60 can be oriented approximately 120 degrees apart about each of the plurality of filament 50 axis, with each lateral wall 60 extending substantially along the longitudinal length of the filament 50. However, in alternative embodiments, an offset hexagonal pattern may be utilized, in which some of the lateral walls 60 may be arranged at 120 degrees, while other lateral walls 60 may be arranged at greater than or less than 120 degrees or an irregular hexagon pattern may be used, in which the lateral walls 60 are not symmetrical in their positioning and/or arrangement. Alternatively, the lateral walls 60 can be oriented approximately 75 to 135 degrees apart about each of the plurality of filament 50 axis, with each lateral wall 60 extending substantially along the longitudinal length of the filament 50.

In the disclosed embodiment, each pair of filaments 50 is connected by a lateral wall 60, with a flat sheet or face plate 70 connecting the top ends of the plurality of filaments 50. A vertical force (i.e., an axial compressive “impact”) downward on the plurality of filaments 50 will desirably induce the filaments 50 to compress to some degree in initial resistance to the force, with a sufficient vertical force eventually inducing the filaments 50 to buckle. However, the presence of the lateral sheet 60 will desirably prevent and/or inhibit buckling of the filaments 50 in a lateral direction away from the lateral sheet 70, as well as possibly prevent and/or inhibit sideways buckling of the filaments 50 (and/or buckling towards the wall) to varying degrees—generally depending upon the thickness, structural stiffness and/or material construction of the various flat sheets 70, as well as various other considerations. In many cases, the most likely direction(s) of buckling of the filaments 50 as depicted may be transverse to the flat sheet 70, which stiffens the resistance of the filaments 50 to buckle along various lateral directions, to a measurable degree in a desired and controllable manner. In the exemplary hexagonal configuration, each of the plurality of filaments 50 is connected by lateral walls 60 to a pair of adjacent filaments 50, with two walls extending from and/or between each filament set. In this arrangement, an axial compressive force will desirably induce each of the plurality of filaments 50 to initially compress to some degree in resisting the axial force, with a sufficient vertical force inducing the at least a portion of filaments 50 to buckle in a desired manner. The presence of the two lateral walls 60, however, with each wall separated at an approximately 120 degree angle, tends to limit lateral displacement of each of the plurality of filaments 50 away from and/or towards various directions, effectively creating a circumferential or “hoop stress” within the filaments/walls of the hexagonal element that can alter, inhibit and/or prevent certain types, directions and/or degrees of bucking of the individual filaments 50, of the individual walls 60 and/or of the entirety of the hexagonal structure.

In various embodiments, the presence of the lateral walls 60 between the each of the plurality filaments 50 of the hexagonal releasable impact mitigation fastening structure 10 can greatly facilitate recovery and/or rebound of the plurality of filaments 50 and hexagonal elements of the releasable impact mitigation fastener 10 as compared to the independent filaments within a traditional filament bed. During buckling and collapse of at least a portion of the filaments 50 and/or hexagonal structure, the lateral walls 60 desirably constrain and control filament “failure” in various predictable manners, with the lateral walls 60 and/or a portion of the filaments 50 elastically deforming in various ways, similar to the “charging” of a spring, as the hexagonal releasable impact mitigation fastening structure 10 collapses. When the compressive force is released from the hexagonal releasable impact mitigation fastening structure 10, the lateral walls 60 and at least a portion of the filaments 50 should elastically deform back to their original “unstressed” or pre-stressed sheet-like condition, which desirably causes the entirety of the hexagonal releasable impact mitigation fastening structure 10 and associated filaments 50/lateral walls 60 to quickly “snap back” to their original position and orientation, immediately ready for the next compressive force. By incorporating such features into a releasable impact mitigation fastening structure 10 between moveable components of a helmet, the present invention allows for securely connecting these components in relationship to each other while maximizing impact performance of the protective gear.

In various embodiment, there are many component features of the releasable impact mitigation fastener 10 that could be altered to influence the directionality and/or magnitude of impact mitigation and/or decoupling of the releasable impact mitigating fastener. For example, the width, surface angles, size, shape and/or material selection of the circular rim 130 can increase and/or decrease the decoupling force magnitude and/or directionality. Similarly, the width, surface angles, size, shape and/or material selection of the lower ridge 30 can increase and/or decrease the decoupling force magnitude and/or directionality.

In various embodiments, the following characteristics of the releasable impact mitigating fastener could be particularized, including one of more of the following: durability, high deformation hits/compressive forces, tension/pull out, releasable impact mitigating fastener tear out in tension or shear, t-nut tearing at corners/edges, buckling force—possibility is to use a higher strength material and design in a lower buckling force (i.e., tapered or notched columns, etc.), rotation (may include keying the body/pod to prevent rotation relative to one of more connected components and/or between components), general stiffness—may desire the connector to be less stiff than the impact absorbing members/array to reduce potential for pressure points and/or force concentrations between attached components, t-nut access—may be desirable for body to be hollow to allow for inter access to screw/t-nut assembly, indexing features for alignment during bonding and/or assembly.

In various embodiments, a variety of connection methods may be utilized to bond or otherwise connect various releasable impact mitigation fastener 10 components (e.g., the lower portion 100 and/or the face plate 70, and/or the circumferential groove 40 to the circular rim 130) to other helmet components, such as the inner shell, the outer shell, pads, electronics, facemasks, and/or other impact absorbing features, including, friction fit or press-fit, snaps (i.e., interference fit connectors), permanent and/or temporary bonds, heat staking or welding, ultrasonic welding, screws/t-nuts, rivets, co-moldings and/or co-molded components, captured flanges, including connectors secured by any of the above methods or others known in the art.

Various exemplary components that could be connected using the disclosed releasable impact mitigation fasteners include virtually any helmet components, including inner and/or outer shells, impact absorbing structures, impact and/or comfort pad assemblies, electronics, ear protectors, facemask component, chin straps, jaw pads, skull caps and/or the like.

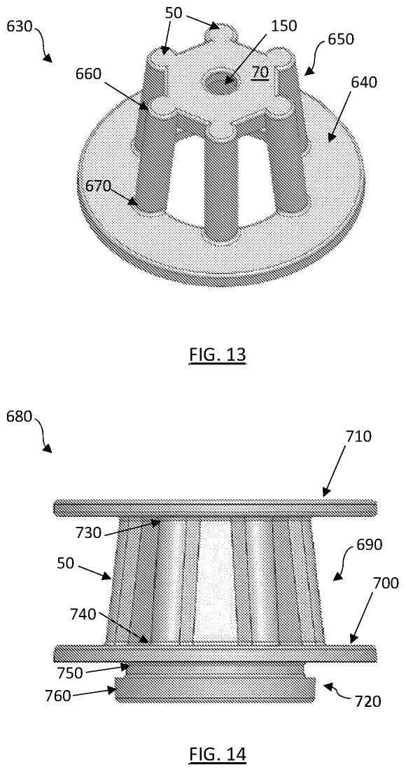

In various alternative embodiments, releasable impact mitigating fastener bodies could comprise other geometric designs, including the use of various numbers of filaments (i.e., 3, 4, 5, 6, 7, 8 or 9 or more filaments in a releasable impact mitigating fastener), and/or releasable impact mitigating fasteners without connecting walls and/or sheets (see FIG. 13), and/or releasable impact mitigating fasteners having filaments/columns with different cross sections between filaments. If desired, a releasable impact mitigating fastener can be designed having an opening/flange connection at both top and bottom of the structure, which could obviate the use of and/or need for t-nuts or similar fastening components in such a design. Alternatively, a releasable impact mitigating fastener sub component or other connective structure could be molded and/or imbedded within the releasable impact mitigating fastener structure.

In at least one alternative embodiment, a releasable impact mitigating fastener could be designed that accommodates attachment directly to an opening in a helmet shell or other component, with at least a portion of the releasable impact mitigating fastener body extending through the shell (and/or over the outer/inner plane of the outer/inner shell, respectively) and retained therein (i.e., with the shell surface mimicking the base described in other embodiments). In at least one alternative embodiment, a releasable impact mitigating fastener could be designed that includes an upper surface for attachment (via adhesive, for example) directly to an inner surface of an outer shell, with the releasable impact mitigating fastener further including a lower flanged region for attachment through an opening in an inner shell (see FIG. 14) as described in various embodiments herein.

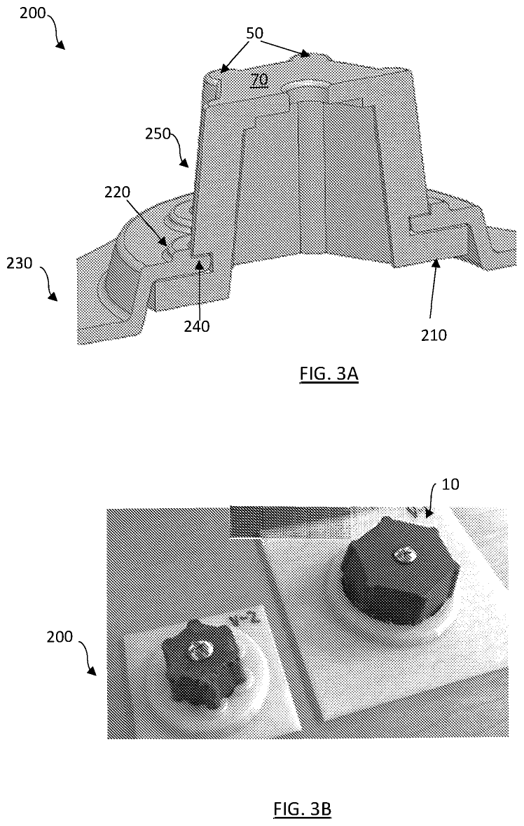

FIGS. 3A-3B depicts various views of an alternate embodiment of a releasable impact mitigating fastener 200. The releasable impact mitigating fastener 200 comprises an upper body 250, the upper body 250 having an outer diameter that has been “scaled down” to reduce the total releasable impact mitigating fastener 200 size, but desirably retaining a minimum diameter to provide a user with access to the screw and/or nut within the releasable impact mitigating fastener 200. In this embodiment, the releasable impact mitigating fastener 200 comprises an upper body 250, a lower flange 210, a face plate 70, and a base 230. The releasable impact mitigating fasteners 200 may further comprise first end proximate to an inner surface of the outer shell, and a second end proximate to the outer surface of the inner shell. In other embodiments, the releasable impact mitigating fasteners 200 may comprise a first end and a second end, the first end may comprise a face plate 70, the first end may be coupled to the inner shell and/or the outer shell. The second end may be coupled to the inner shell and/or outer shell.

The lower flange 210 of the releasable impact mitigating fastener 200 is a generally circular configuration and/or a polygonal configuration and generally larger than in the previous embodiment and/or extend greater than the diameter of the upper body 250, which could alternatively include the use of a bonded stiffener or “retainer ring” (not shown) to increase the “pull out” resistance of the releasable impact mitigating fastener 200 (which could be over-molded in production, if desired). Increasing the extension length and/or the diameter of the lower flange 210 may increase and/or decrease the “pull out” resistance of the releasable impact mitigating fastener 200. This disclosed embodiment of the releasable impact mitigating fastener 200, may comprise a base 230, the base 230 may further comprise features to accommodate additional securement to the inner and/or outer shell. The base 230 may comprise an independent component that may be coupled to the outer shell (not shown) and/or to the inner shell (not shown) and/or the connector base 230 may comprise at least a portion of the inner shell or outer shell. The at least a portion of the inner shell and/or outer shell may extend upwardly to form a protrusion from the remaining portions of the inner shell and/or outer shell.

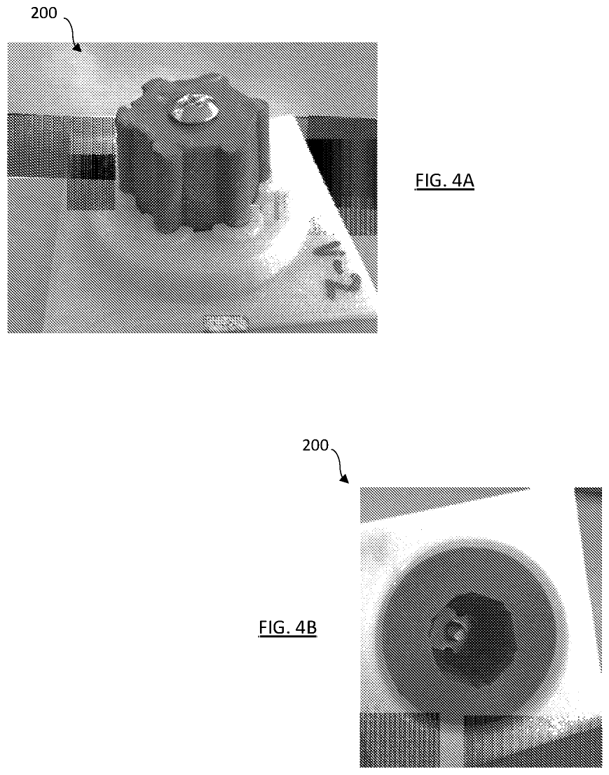

In one embodiment, a t-nut or other known releasable impact mitigating fastener or retention mechanism for attachment to helmet components, and if desired a slightly larger filament overlap (over the top of the lower base) and/or placement of a raised ridge 220 can be disposed onto the base 230, the raised ridge 220 may extend perpendicularly upward from the base 230, providing a raised edge or protrusion that contacts the upper body 250. Such raised ridge 220 may increase releasable impact mitigating fastener stiffness and/or strength, as well as the “pull out” resistance. If desired, a keyway or anti-rotation feature could be incorporated into the releasable impact mitigating fastener 200, as desired. FIGS. 4A-4B depict an isometric top view and bottom view of the releasable impact mitigating fastener 200 as shown in FIG. 3A-3B.

In other exemplary embodiments, releasable impact mitigating fastener 200 alterations could include reduced component size (i.e., optimizing offset of a boss, for example, to make as small as possible), as well as design to optimize releasable impact mitigating fastener tear-out. If desired, materials changes could be incorporated to increase material strength, which could optimally include geometry changes to the releasable impact mitigating fastener components to reduce the buckling force of the releasable impact mitigating fastener body. Accordingly, one or more the filaments 50 may have various configurations, such as longer length, different thinner and/or wider diameters.

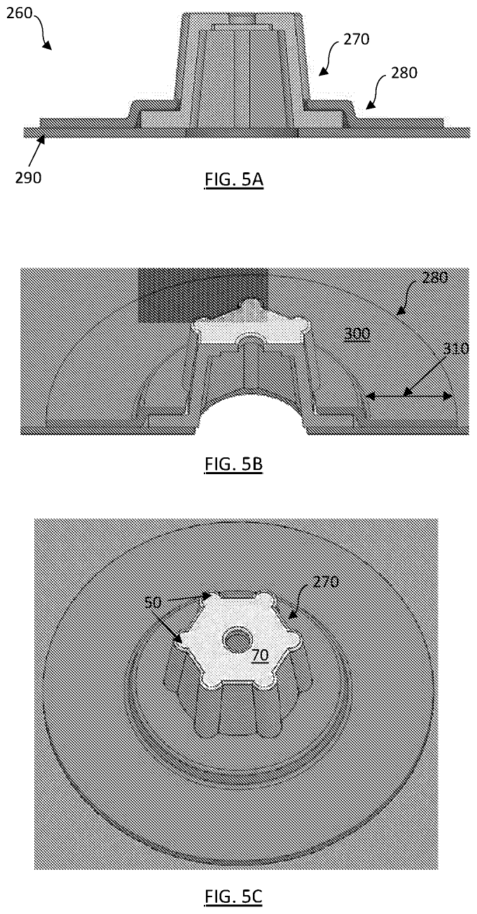

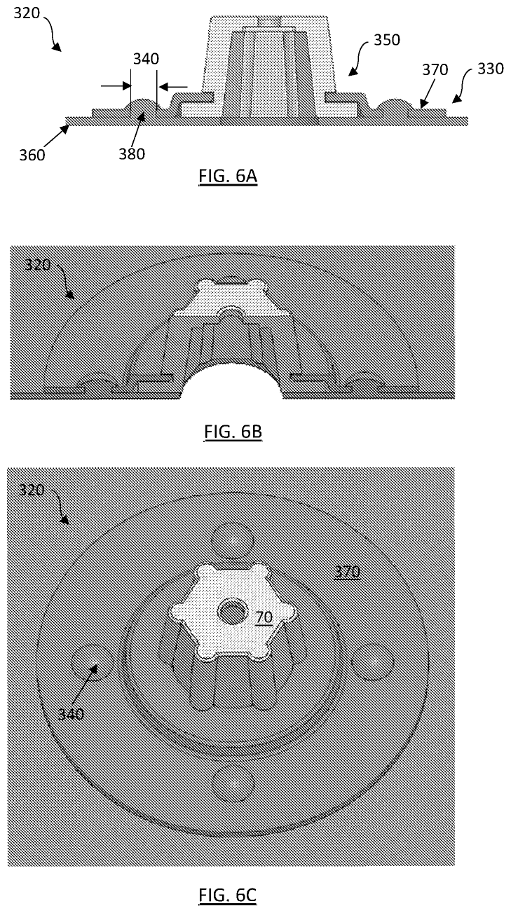

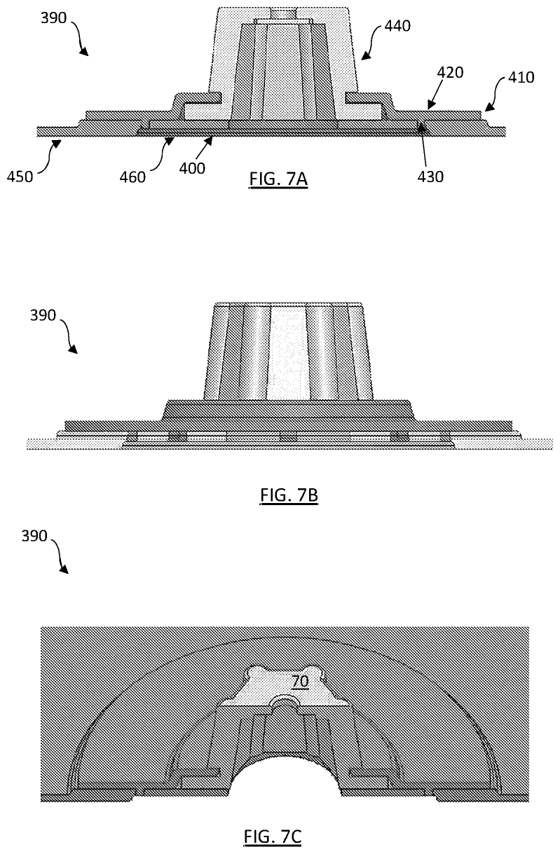

FIGS. 5A through 5C and 6A through 6C depict various alternative embodiments of an alternate releasable impact mitigating fastener 260. The releasable impact mitigating fastener 260 may comprise an upper body 270, a base 280, and an inner or outer shell 290. The releasable impact mitigating fasteners 260 may further comprise first end proximate to an inner surface of the outer shell, and a second end proximate to the outer surface of the inner shell. In other embodiments, the releasable impact mitigating fasteners 200 may comprise a first end and a second end, the first end may comprise a face plate 70, the first end may be coupled to the inner shell and/or the outer shell. The second end may be coupled to the inner shell and/or outer shell, the second end may comprise one or more flanges.

The base 280 may include a separate flange component 300, wherein the flange 300 can comprise an extension or diameter 310 component that can be adhered, attached or otherwise connected to an underlying helmet inner and/or outer shell 290 (i.e., bonding, welding, heat-staking, riveting, fastening, etc). In this embodiment, the presence of the underlying inner and/or outer shell 290 could assist with resistance to “push through” compressive loading on the releasable impact mitigating fastener 260. Furthermore, the upper body 290 may comprise a frustum shaped laterally supported filament structure.

Alternatively, FIGS. 6A-6C depicts various views of an alternate embodiment of a releasable impact mitigating fastener 320. The releasable impact mitigating fastener 320 may comprise an upper body 350, a base 330, and/or an inner and/or outer shell 360. The base 330 may comprise a flange 370, the flange 370 having one or more openings 340. The one or more openings 340 may be arranged asymmetric and/or symmetric around the perimeter of the flange 370. The one or more openings 340 may be used to insert rivets, screws, and/or other small retention mechanisms 380. The retention mechanisms 380 may be incorporated onto the inner and/or outer shell 360 and/or inserted separately into the inner and/or outer shell 360.

The releasable impact mitigating fasteners 320 may further comprise first end proximate to an inner surface of the outer shell, and a second end proximate to the outer surface of the inner shell. In other embodiments, the releasable impact mitigating fasteners 320 may comprise a first end and a second end, the first end may comprise a face plate 70, the first end may be coupled to the inner and/or the outer shell 360 The second end may be coupled to the inner shell and/or outer shell 360. The base 330 may include a separate flange 370, wherein the flange 370 can comprise an extension or diameter section that can be adhered, attached or otherwise connected to an underlying helmet inner and/or outer shell 360 (i.e., bonding, welding, heat-staking, riveting, fastening, etc). In this embodiment, the presence of the underlying inner and/or outer shell 360 could assist with resistance to “push through” compressive loading on the releasable impact mitigating fastener 320. Furthermore, the upper body 350 may comprise a frustum shaped laterally supported filament structure.

FIGS. 7A-7C depicts various views of another alternative embodiment of a releasable impact mitigating fastener 390. The releasable impact mitigating fastener 390 comprises an upper body 440, a base 410, and/or an inner and/or outer shell 450. The releasable impact mitigating fasteners 320 may further comprise first end proximate to an inner surface of the outer shell, and a second end proximate to the outer surface of the inner shell. In other embodiments, the releasable impact mitigating fasteners 390 may comprise a first end and a second end, the first end may comprise a face plate 70, the first end may be coupled to the inner and/or the outer shell 450 The second end may be coupled to the inner shell and/or outer shell 450.

The inner and/or outer shell 450 may have a recess 460 in which a separate “snap flange” 400 that can be secured to the bottom of the recess 460. The releasable impact mitigating fastener 390 being secured below the surface of an inner and/or outer shell 450 within the recess 460 may significantly increase the resistance of the releasable impact mitigating fastener 390 to pull through and/or “push through,” as well as potentially alter the bucking strength of the releasable impact mitigating fastener upper body 440.

The releasable impact mitigating fastener base 410 may comprise a base flange 420, the base flange 420 may have one or more protrusions 430 that extend perpendicularly away from a first or second surface of the flange 420. The one or more protrusions 420 may be sized and configured to fit into or interlock with the corresponding notches or recesses disposed within a surface of the inner and/or outer shell 450. Alternatively, the fixation arrangement can be designed similar to a “dove-tail” joint. The one or more protrusions 430 may be arranged asymmetrically and/or symmetrically around the perimeter of the flange 420. The base 410 may include a separate flange 420, wherein the flange 420 can comprise an extension or diameter section that can be adhered, attached or otherwise connected to an underlying helmet inner and/or outer shell 360 (i.e., bonding, welding, heat-staking, riveting, fastening, etc). In this embodiment, the presence of the underlying inner and/or outer shell 450 could assist with resistance to “push through” compressive loading on the releasable impact mitigating fastener 390. Furthermore, the upper body 440 may comprise a frustum shaped laterally supported filament structure.

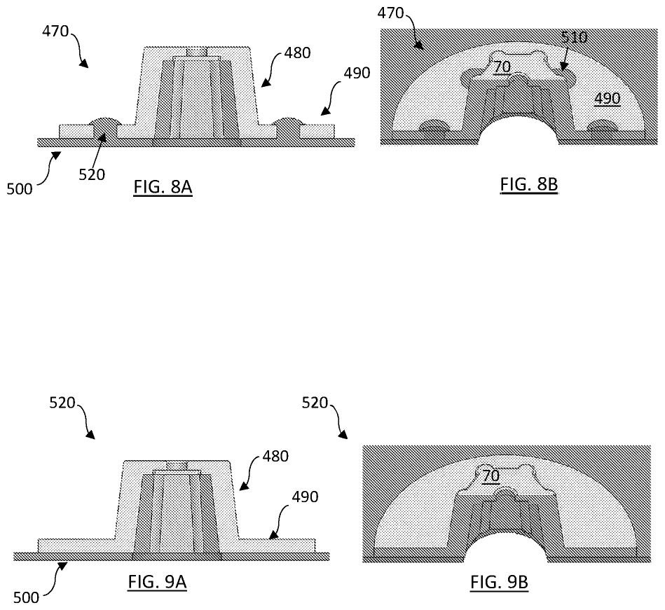

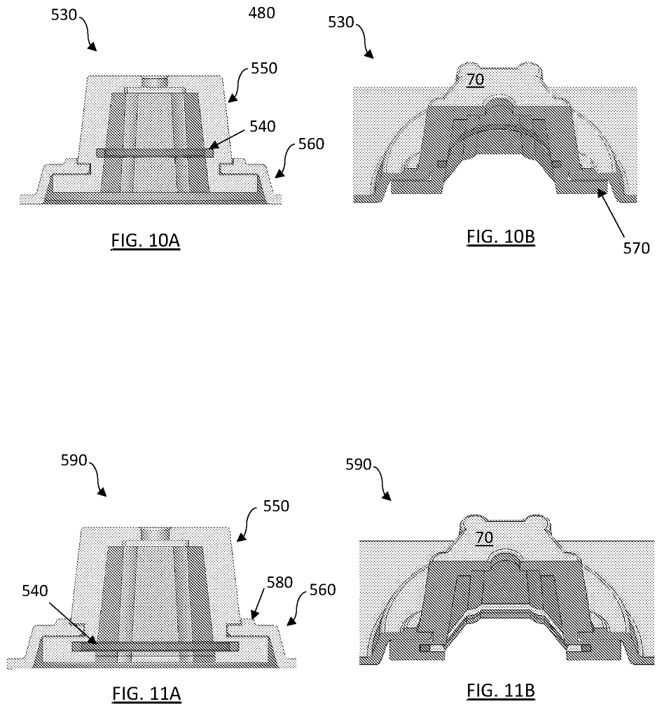

FIGS. 8A-8B and 9A-9B depict different views of various alternative embodiments of releasable impact mitigating fasteners 470, 520 that can be directly attached to underlying helmet structures without the need for a separate base plate components. The releasable impact mitigating fasteners 470, 520 may comprise an upper body 480 and a flange 490. The releasable impact mitigating fasteners 470, 520 may further comprise first end proximate to an inner surface of the outer shell, and a second end proximate to the outer surface of the inner shell. In other embodiments, the releasable impact mitigating fasteners 470, 520 may comprise a first end and a second end, the first end may comprise a face plate 70, the first end may be coupled to the inner and/or the outer shell 500. The second end may be coupled to the inner shell and/or outer shell 500.

The flange 490 may extend axially or laterally away from the perimeter of the upper body 480. The base 490 may be extend perpendicular from the upper body 580. The base 490 may have varying diameters, and the base 490 may be affixed to the inner and/or outer shell 500, where such affixation and/or attachment could be temporary and/or permanent, and could be accomplished using various fastening techniques known to those of ordinary skill in the releasable impact mitigating fastener art. Furthermore, the one or more openings 510 may be arranged asymmetric and/or symmetric around the perimeter of the base 490. The one or more openings 510 may be used to insert rivets, screws, and/or other small retention mechanisms 520. The retention mechanisms 520 may be incorporated onto the inner and/or outer shell 500 and/or inserted separately into the inner and/or outer shell 500. The flange 370, wherein the flange 370 can comprise an extension or diameter section that can be adhered, attached or otherwise connected to an underlying helmet inner and/or outer shell 360 (i.e., bonding, welding, heat-staking, riveting, fastening, etc). Furthermore, the upper body 350 may comprise a frustum shaped laterally supported filament structure.

FIGS. 10A-10B and 11A-11B depict various views of other alternative embodiments of releasable impact mitigating fasteners 530, 590 that can incorporate internal stiffeners or retention rings (not shown). The releasable impact mitigating fasteners 530, 590 comprises an upper body 550 and a flange 570 and a base 560. The releasable impact mitigating fasteners 530,590 may further comprise first end proximate to an inner surface of the outer shell, and a second end proximate to the outer surface of the inner shell. In other embodiments, the releasable impact mitigating fasteners 530,590 may comprise a first end and a second end, the first end may comprise a face plate 70, the first end may be coupled to the inner shell and/or the outer shell. The second end may be coupled to the inner shell and/or outer shell, the second end may comprise one or more flanges 570.

The releasable impact mitigating fasteners upper body 550 may comprise a channel 540, the channel 540 may be disposed onto an interior surface of the upper body 550, the channel 540 may follow an interior perimeter of the upper body 550. The channel 540 may be sized and configured to receive a retaining ring (not shown). An internal retaining ring may desirably reduce/prevent collapse and/or “push through” of the releasable impact mitigating fastener body (FIG. 10A) as well as rings that could prevent and/or reduce “pull through” of the releasable impact mitigating fastener and provide for radial stability and/or circumferential strength during collapse and/or buckling, and/or provide an axial deflection positive stop during an impact for enhanced compression strength. If desired, the retaining ring could comprise a spilt or expanded c-ring that allows for insertion of the releasable impact mitigating fastener into the base with the ring already in position, or a separate ring could be inserted into the releasable impact mitigating fastener after placement into the base (i.e., a “locking ring” concept). The flange 570 may extend axisymetrically and/or circumferentially away from the upper body 550.

In another embodiment, the channel 540 may be disposed within the flange 560, the channel 540 may be disposed onto an interior surface of the flange 570 as shown in FIGS. 11A-11B. The channel 540 may follow an interior perimeter of the flange 570. The channel 540 may be sized and configured to receive a retaining ring (not shown), the retention ring may be disposed within the channel 540. Such placement or positioning within the flange 570 may provide additional tensile, “pull-through” and/or shear resistance. Alternatively, the releasable impact mitigation fasteners 530, 590 may have one or more channels 540 that may be positioned in the upper body 550 and/or within the flange 570. Additionally, two or more retention rings may be disposed in the upper body 550 and the flange 570 may collectively enhance and/or “lock” the releasable impact mitigating fastener 530, 590 to the base 560. The base 560 may comprise an independent component that may be coupled to the outer shell (not shown) and/or to the inner shell (not shown) and/or the base 560 may comprise at least a portion of the inner shell or outer shell. The base 560 may be integrated with the inner and/or outer shell where the at least a portion of the inner shell and/or outer shell may extend upwardly to form a protrusion from the remaining portions of the inner shell and/or outer shell. The base 560 may be coupled to the inner and/or outer shell, and the face plate may be coupled to the inner and/outer shell.

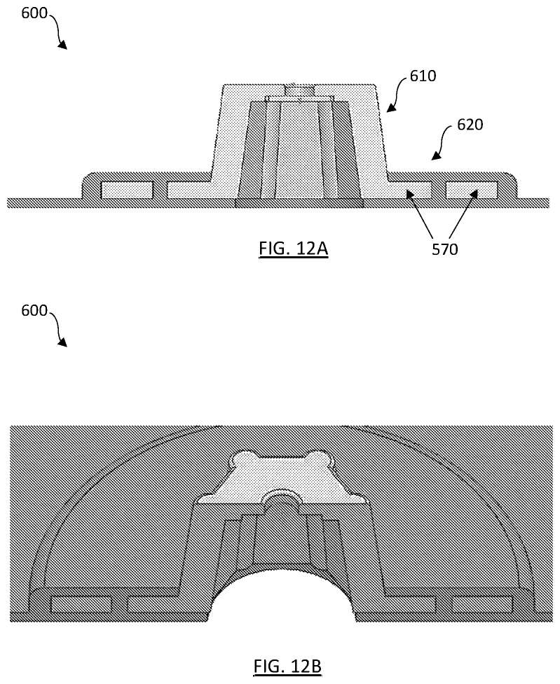

FIGS. 12A-12B depict another alternative embodiment of a releasable impact mitigating fastener 600. The releasable impact mitigating fastener 600 an upper body 610, a flange 570 and an overmolded base 620, wherein the releasable impact mitigating fastener 600 can be placed within a mold and then the base 620 component is over molded to secure the releasable impact mitigating fastener 600 to the helmet component.

FIG. 13 depicts an isometric view of another alternative embodiment of a releasable impact mitigating fastener 630. The releasable impact mitigating fastener 650 comprises an upper body 650, a flange 640 and a face plate 70. The releasable impact mitigating fasteners 630 may further comprise first end proximate to an inner surface of the outer shell, and a second end proximate to the outer surface of the inner shell. In other embodiments, the releasable impact mitigating fasteners 630 may comprise a first end and a second end, the first end may comprise a face plate 70, the first end may be coupled to the inner and/or the outer shell. The second end may be coupled to the inner shell and/or outer shell, the second end may comprise one or more flanges 640.

The upper body 650 comprises an impact structure, the impact structure comprises a plurality of filaments 50, the plurality of filaments 50 are arranged in a circle and/or a polygonal shape. Each of the plurality of filaments 50 are positioned to an adjacent filament 50 to form a circle and/or a polygonal shape. The polygonal shapes may include a triangle, a square, a rectangle, a pentagon, a septagon, a heptagon, an octagon, and/or any combination thereof. Each of the plurality of filaments 50 have a first end 660 and a second end 670. The first end 660 of each of the plurality of filaments 50 are coupled to the face plate 70. The second end 670 of each of the plurality of filaments are connected to the flange 640. The flange 640 may optionally comprise one or more protrusions (not shown) and/or one or more openings (not shown) being symmetrically positioned and/or asymmetrically positioned around the circumference of the filaments 50. Furthermore, the upper body 650 may be frustum shaped. The face plate may comprise one or more openings 150. The upper body 650 may further comprise a frustum shape.

FIG. 14 depicts a side view of another alternative embodiment of a releasable impact mitigating fastener 680. The releasable impact mitigating fastener 680 comprises an upper body 690, a first flange 710, a second flange 700, and an insert body 720. The releasable impact mitigating fasteners 680 may further comprise first end proximate to an inner surface of the outer shell, and a second end proximate to the outer surface of the inner shell. In other embodiments, the releasable impact mitigating fasteners 680 may comprise a first end and a second end, the first end may comprise a face plate 70, the first end may be coupled to the inner and/or the outer shell. The second end may be coupled to the inner shell and/or outer shell, the second end may comprise one or more flanges 700,710.

The first flange 710 and/or second flange 700 may include an exterior or an upper surface for attachment (via adhesive, for example) directly to an inner surface of an outer shell and/or an external surface of an inner shell. Alternatively, the first flange 710 and/or second flange 700 may be inserted into a first base (not shown) and/or a second base (not shown), the base being independent and coupled to the inner and/or outer shell, and/or the first and/or second base being integral with the inner and/or outer shell. The upper body 690 comprises an impact mitigation structure, the impact mitigation structure comprises a plurality of filaments 50, the plurality of filaments 50 are arranged in a circle and/or a polygonal shape. Each of the plurality of filaments 50 are positioned to an adjacent filament 50 to form a circle and/or a polygonal shape. The polygonal shapes may include a triangle, a square, a rectangle, a pentagon, a septagon, a heptagon, an octagon, and/or any combination thereof. Each of the plurality of filaments 50 have a first end 730 and a second end 740. The first end 730 of each of the plurality of filaments 50 are coupled to first flange 710 or second flange 700. The second end 730 of each of the plurality of filaments are connected to the first flange 710 or the second flange 700. The first flange 710 and/or the second flange 700 may optionally comprise one or more protrusions (not shown) and/or one or more openings (not shown) being symmetrically positioned and/or asymmetrically positioned around the circumference of the filaments 50. Furthermore, the upper body 690 may be frustum shaped. The first flange 710 and/or the second flange 700 may comprise one or more openings 150 and/or one or more protrusions (not shown).

Furthermore, the releasable impact mitigating fastener 680 further including an insert body portion 720. The insert body portion 720 may be disposed onto the first flange 710 and/or the second flange 700, with the insert body portion 720 extending perpendicularly away from the first flange 710 and/or second flange 700. The insert body portion 720 may have a top portion 750 and a bottom portion 760, the top portion 750 being a smaller diameter than the bottom portion 760. The top portion 750 being sized and configured to receive a portion of the base (not shown).

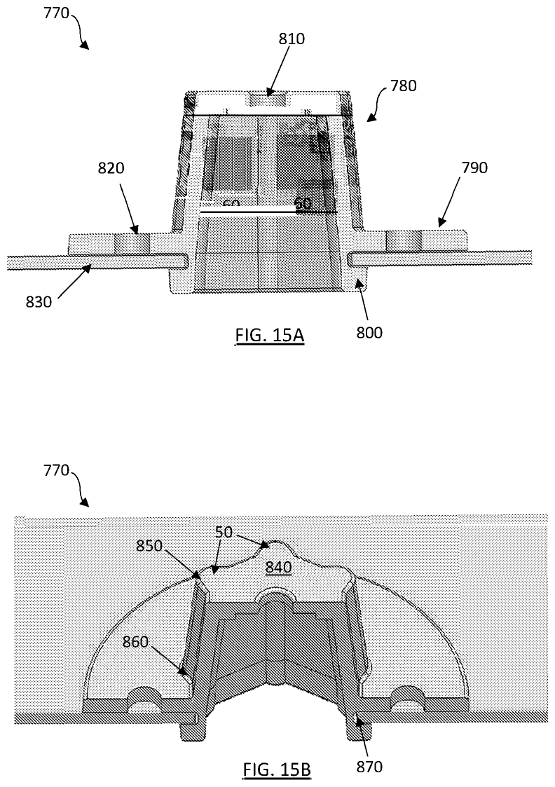

FIGS. 15A-15B depict various cross-sectional views of another alternative embodiment of a releasable impact mitigating fastener 770. The releasable impact mitigating fastener 770 comprises an upper body 780, a first flange 790, a second flange 800, and a face plate 840. The face plate 840 may comprise at least one opening 810. The releasable impact mitigating fasteners 770 may further comprise first end proximate to an inner surface of the outer shell, and a second end proximate to the outer surface of the inner shell. In other embodiments, the releasable impact mitigating fasteners 770 may comprise a first end and a second end, the first end may comprise a face plate 70, the first end may be coupled to the inner and/or the outer shell 830. The second end may be coupled to the inner shell and/or outer shell 830, the second end may comprise one or more flanges 790, 800.

The upper body 780 comprising an impact mitigation structure, the impact mitigation structure being a laterally supported filament structure. The laterally supported filament structure comprises a plurality of filaments 50 and a plurality of walls 60, which each of the plurality of filaments 50 are positioned to an adjacent filament 50 to form a circle shape and/or a polygonal shape. Each of the plurality of filaments 50 coupled by the plurality of walls 60. The polygonal shapes may include a triangle, a square, a rectangle, a pentagon, a septagon, a heptagon, an octagon, and/or any combination thereof. Each of the plurality of filaments 50 comprising a first end 850 and a second end 860. The face plate 840 being coupled to the first end 850.

The first flange 790 has a greater diameter than the second flange 800, which can significantly reduce the opportunity for the releasable impact mitigating fastener 770 to “push through” the lower opening in response to compressive loading of the releasable impact mitigating fastener 770. Each of the first flange 790 and the second flange 770 may be coupled to a portion of the second end 860. The first flange 790 and/or the second flange 800 may also comprise one or more openings, where different types of retention mechanisms may be used to secure the first flange 790 and/or the second flange 800 to the opposing material. The first flange 790 is separated by a space from the second flange 800 to create a channel 870. The channel 870 is sized and configured to receive a portion of the inner and/or outer shell 830 and/or a base (not shown). If desired, the releasable impact mitigating fastener 770 could be secured to the underlying base only mechanically (i.e., “snap in” flanges) or in conjunction with other securement such as snaps, bonding, adhesives and/or other releasable impact mitigating fasteners.

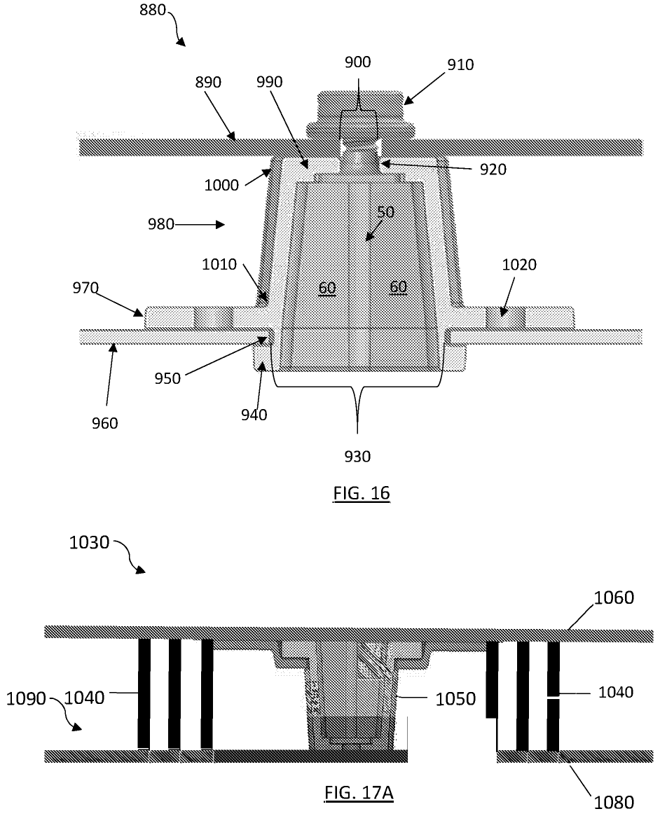

FIG. 16 depicts a cross-sectional view of another exemplary embodiment of a releasable impact mitigating fastener 880. The releasable impact mitigating fastener 880 may comprise an upper body 970, a first flange 940, a second flange 970, a t-nut 910 and a face plate 990. The releasable impact mitigating fastener 880 is shown in an assembled condition between an outer helmet shell 890 and an inner helmet shell 960. The releasable impact mitigating fasteners 880 may further comprise first end proximate to an inner surface of the outer shell, and a second end proximate to the outer surface of the inner shell. In other embodiments, the releasable impact mitigating fasteners 880 may comprise a first end and a second end, the first end may comprise a face plate 990, the first end may be coupled to the inner and/or the outer shell 960. The second end may be coupled to the inner shell and/or outer shell 960, the second end may comprise one or more flanges 940,970.

The face plate 990 may comprise at least one opening 900. The upper body 980 comprising an impact mitigation structure, the impact mitigation structure being a laterally supported filament structure. The laterally supported filament structure comprises a plurality of filaments 50 and a plurality of walls 60, which each of the plurality of filaments 50 are positioned to an adjacent filament 50 to form a circle shape and/or a polygonal shape. Each of the plurality of filaments 50 coupled by the plurality of walls 60. The polygonal shapes may include a triangle, a square, a rectangle, a pentagon, a septagon, a heptagon, an octagon, and/or any combination thereof. Each of the plurality of filaments 50 comprising a first end 1000 and a second end 1010. The face plate 990 being coupled to the first end 1000.

The first flange 940 has a greater diameter than the second flange 970, which can significantly reduce the opportunity for the releasable impact mitigating fastener 880 to “push through” the lower opening in response to compressive loading of the releasable impact mitigating fastener 880. Each of the first flange 940 and the second flange 970 may be coupled to a portion of the second end 1010. The first flange 940 and/or the second flange 970 may also comprise one or more openings 1020, where different types of retention mechanisms may be used to secure the first flange 940 and/or the second flange 970 to the opposing material. The first flange 940 is separated by a space from the second flange 970 to create a channel 950. The channel 950 is sized and configured to receive a portion of the inner and/or outer shell 890, 960 and/or a base (not shown). The first flange 940 and/or the second flange 970 desirably abuts against an outer surface of the inner shell 960 and/or an internal surface of the outer shell 890, thereby inhibiting and/or preventing “push through” of the releasable impact mitigating fastener 880 during helmet impact events (i.e., downward impacting forces on the outer shell 890). A t-nut 910 or similar securement feature is provided within an upper portion of the releasable impact mitigating fastener 880 and/or is positioned proximate or adjacent to the first end 1000, which attaches to a chinstrap snap/screw through an opening 900 in the outer helmet shell 890, thereby connecting the releasable impact mitigating fastener 880 to the outer helmet shell 890.

While many of the embodiments are described herein as constructed of polymers or other plastic and/or elastic materials, it should be understood that any materials known in the art could be used for any of the devices, systems and/or methods described in the foregoing embodiments, for example including, but not limited to metal, metal alloys, combinations of metals, plastic, polyethylene, ceramics, cross-linked polyethylene's or polymers or plastics, and natural or man-made materials. In addition, the various materials disclosed herein could comprise composite materials, as well as coatings thereon.

Furthermore, it should also be understood that the embodiments disclosed herein used inner and/or outer shells for the substrates in which the various releasable impact mitigation fasteners may be attached to, however, the substrates will vary. For example, the inner and outer shells may be substituted by an inner material and/or an outer material, a first material and/or a second material. The first or second materials may be polymers, foams, metals, fabrics, etc.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure. The invention may be embodied in other specific forms without departing from the spirit or essential characteristics thereof. The foregoing embodiments are therefore to be considered in all respects illustrative rather than limiting on the invention described herein. The scope of the invention is thus intended to include all changes that come within the meaning and range of equivalency of the descriptions provided herein.

Many of the aspects and advantages of the present invention may be more clearly understood and appreciated by reference to the accompanying drawings. The accompanying drawings are incorporated herein and form a part of the specification, illustrating embodiments of the present invention and together with the description, disclose the principles of the invention. Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the disclosure herein.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosed embodiments are intended to be illustrative, but not limiting, of the scope of the disclosure.

### INCORPORATION BY REFERENCE

The entire disclosure of each of the publications, patent documents, and other references referred to herein is incorporated herein by reference in its entirety for all purposes to the same extent as if each individual source were individually denoted as being incorporated by reference.

I/we claim:

1. A releasable impact mitigating fastener comprising:
an upper body, the upper body comprises a first end, a second end and an impact mitigation structure, the first end comprising a face plate, the impact mitigation structure being a laterally supported filament structure, the laterally supported filament structure including a plurality of filaments and an equal number of plurality of lateral walls, each of the plurality of filaments are positioned proximate to an adjacent each of the plurality of filaments to form a polygonal shape, the equal number of the plurality of walls coupling the each of the plurality filaments to the adjacent each of the plurality of filaments.

2. The releasable impact mitigating fastener of claim 1, wherein the second end comprises a flange.

3. The releasable impact mitigating fastener of claim 2, wherein the flange is separated from the upper body by a space.

4. The releasable impact mitigating fastener of claim 1, wherein the polygonal shape comprises a triangle, a square, a rectangle, a pentagon, a hexagon, a septagon, and an octagon.

5. The releasable impact mitigating fastener of claim 1, wherein a portion of the upper body comprises a retaining ring.

6. The releasable impact mitigating fastener of claim 2, wherein a portion of the flange comprises a retaining ring.

7. The releasable impact mitigating structure of claim 1, wherein the face plate comprises at least one opening.
